(19) United States
(12) Patent Application Publication
(10) Pub. No.: US 2004/0066417 A1
(43) Pub. Date: Apr. 8, 2004

(54) Contents protection apparatus and protection method for mixed reality system

(75) Inventors: Mahoro Anabuki, Kanagawa (JP); Hiroyuki Yamamoto, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA

(21) Appl. No.: 10/673,293

(22) Filed: Sep. 30, 2003

(30) Foreign Application Priority Data
Oct. 3, 2002 (JP) 2002-291453

(51) Int. Cl. G09G 5/00

(52) U.S. Cl. 345/848

(57) ABSTRACT

There is disclosed a protection apparatus which can prevent illicit use of contents without any real objects required for the contents, which are included in those for a mixed reality system. A protection apparatus has ID transmission units which are provided in correspondence with real objects required for contents, and transmit unique IDs, an ID reception unit which receives IDs from the ID transmission units, and an ID collation unit for determining whether an execution of the contents is to be authorized or not on the basis of whether or not the received IDs correspond to real objects required to execute the contents. When a main system that provides mixed reality to the user is to execute contents, the protection apparatus determines that execution of the contents is to be authorized or not and sends the determination result to the main system.

### FIELD OF THE INVENTION

The present invention relates to a contents protection apparatus and protection method, which prevent illicit use of contents that are executed by a mixed reality system for superimposing virtual space information on a real space.

### BACKGROUND OF THE INVENTION

In recent years, studies about mixed reality (to be referred to as MR hereinafter) that aims at seamless joint of real and virtual spaces have been extensively made.

MR has received a lot of attention as a technique that aims at coexistence of a world of virtual reality (to be referred to as VR hereinafter) (virtual space) and real space, and augments VR.

Use of MR in new fields qualitatively different from conventional VR is expected, such as a medical assistant application that presents the state in the body of a patient to a doctor as if it were seen through, an operation assistant application that superimposes the assembling order of a product on real objects in a factory, and the like. Especially, in the entertainment field, since MR can design a real world in addition to a virtual world produced by computer graphics (to be referred to as CG hereinafter), the freedom in contents production increases remarkably, and more expectations are placed on MR as a technique which can provide contents that no one has experienced before.

Contents of a system that implements this MR contain CG data which expresses a virtual world, programs for implementing MR, real objects used in the contents (e.g., those used to form a diorama in game contents, weapons that players wear or use, and the like), and data of shapes and positions/orientations unique to these contents. That is, upon selling contents for an MR system, digital data such as CG data, programs, shape data of real objects used in the contents, and the like, and real objects such as shaped articles, and the like are sold together.

Upon selling digital data such as computer programs, photo data, video data, and the like, it is a common practice to take a measure for preventing illicit use due to unauthorized copies and the like.

As conventional measures, software measures such as a method of providing an alphanumeric character string called a “serial number” to an authorized copy, and prompting the user to input the serial number upon installation or first use, a method of encrypting digital data to be sold, and providing a mechanism that allows to decrypt the encrypted data only in authorized use to a purchaser, and the like are known. Also, a measure using a hardware key such as a method of providing a dongle to be connected to an I/O port of a terminal used to access digital data together with the digital data of contents, and inhibiting from using the sold digital data on a terminal to which no dongle is connected is known.

The aforementioned measures are effective to prevent illicit use of digital data of contents only when contents to be sold are formed of only digital data. However, when illicit use of MR contents is to be prevented, since the MR contents contain real objects for the contents in addition to digital data, it is one form of illicit use to execute MR contents without using the real objects. Also, it is another form of illicit use to execute an MR system using unauthorized real objects.

However, the conventional measures can prevent illicit use of digital data but cannot prevent illicit use of real objects. That is, since digital data can be used if a serial number, hardware key, or the like is available, MR contents can be executed without any real objects contained in the contents.

### SUMMARY OF THE INVENTION

The present invention has been made to solve the conventional problems, and has as its object to provide a protection apparatus and protection method, which prevent illicit use of contents for an MR system by inhibiting the contents from being executed in the MR system without any authorized real objects contained in the MR system contents even when programs and data contained in the contents exist.

According to an aspect of the present invention, mixed reality contents protection apparatus for preventing illicit use of contents for a mixed reality system that mixes and presents a virtual space image on a landscape of a real space, comprising: ID transmission unit, attached to a real object, adapted to transmit a predetermined ID; ID reception unit adapted to receive the ID; and ID collation unit adapted to determine whether an execution of the contents by the mixed reality system is to be authorized or not on the basis of whether or not the received ID corresponds to a real object required for the contents to be executed by the mixed reality system, and sending a determination result to the mixed reality system.

According to another aspect of the present invention, mixed reality contents protection method for preventing illicit use of contents for a mixed reality system that mixes and presents a virtual space image on a landscape of a real space, comprising: an ID transmission step of making an ID transmission unit attached to a real object transmit a predetermined ID; an ID reception step of receiving the ID; and an ID collation step of determining whether an execution of the contents by the mixed reality system is to be authorized or not on the basis of whether or not the received ID corresponds to a real object required for the contents to be executed by the mixed reality system, and sending a determination result to the mixed reality system.

According to further aspect of the present invention, computer readable recording medium storing a program code for making a computer execute a method for preventing illicit use of contents for a mixed reality system that mixes and presents a virtual space image on a landscape of a real space, said program code comprising: a program code of an ID transmission step of making an ID transmission unit attached to a real object transmit a predetermined ID; a program code of an ID reception step of receiving the ID; and a program code of an ID collation step of determining whether an execution of the contents by the mixed reality system is to be authorized or not on the basis of whether or not the received ID corresponds to a real object required for the contents to be executed by the mixed reality system, and sending a determination result to the mixed reality system.

Other features and advantages of the present invention will be apparent from the following description taken in conjunction with the accompanying drawings, in which like reference characters designate the same name or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a schematic block diagram for explaining the arrangement of an MR system using a contents protection apparatus for a mixed reality system according to the first embodiment of the present invention;

FIG. 2 illustrates a state upon using the MR system shown in FIG. 1;

FIG. 3 is a sequence chart for explaining the processing sequence of a contents protection apparatus 100 in the first embodiment of the present invention;

FIG. 4 is a schematic block diagram for explaining the arrangement of an MR system using a contents protection apparatus for a mixed reality system according to the second embodiment of the present invention; and

FIG. 5 is a sequence chart for explaining the processing sequence of a contents protection apparatus 100′ in the second embodiment of the present invention.

### DETAILED DESCRIPTION OF THE PREFERRED EMBODIMENTS

Preferred embodiments of the present invention will now be described in detail in accordance with the accompanying drawings.

<First Embodiment>

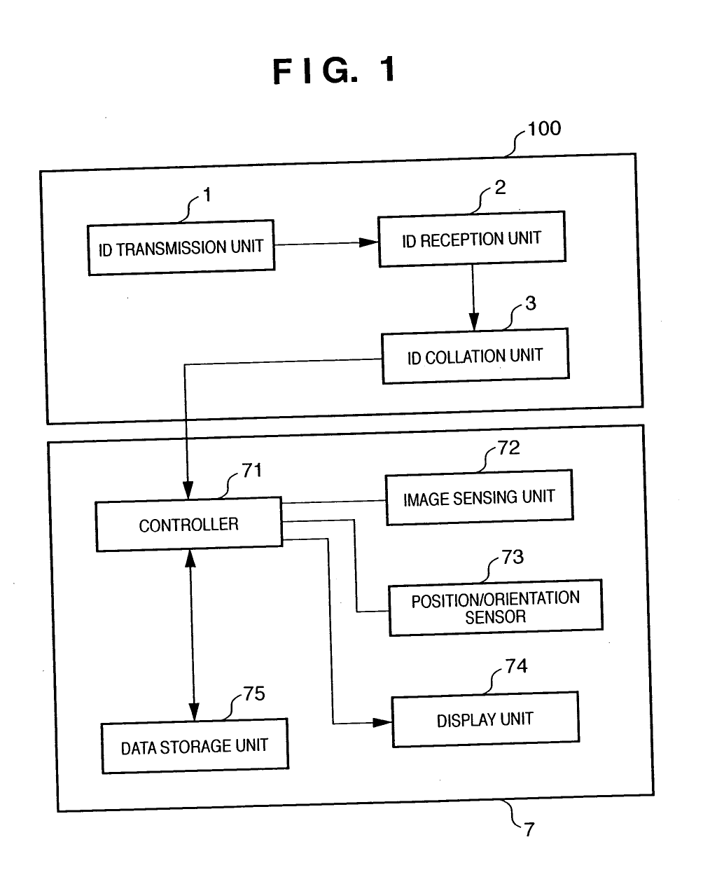

FIG. 1 is a schematic block diagram showing the arrangement of the overall MR system using a contents protection apparatus for an MR system according to the first embodiment of the present invention.

Referring to FIG. 1, an MR system comprises a contents protection apparatus 100 and main system 7, which has a function of executing the MR contents on its own.

(Arrangement of Contents Protection Apparatus 100)

In the contents protection apparatus 100, reference numeral 1 denotes an ID transmission unit which includes not only devices having active transmission functions such as a radio transmitter, infrared light emitter, and the like, but also a marker such as a two-dimensional (2D) barcode. The ID transmission unit 1 is integrated with a real object contained in the MR system contents, and is built in the real object or attached to its surface. The number of ID transmission units 1 may be equal to either that of all real objects contained in the contents or that of representative real objects. Each ID transmission unit 1 transmits an ID used to specify an integrated real object around it via a medium that an ID reception unit 2 can receive. The medium that the ID reception unit 2 can receive includes, e.g., a radio wave, infrared light, and visible light. When a marker is used as the ID transmission unit 1, the ID of a real object to which the marker is attached is detected by reading that marker using a reader (barcode reader, camera, or the like).

Reference numeral 2 denotes an ID reception unit, which comprises, e.g., a radio receiver, an infrared ray camera, or a real space image sensing camera as one of building components of the system that implements MR. This ID reception unit 2 may be integrated with the main system 7. The ID reception unit 2 is connected to a computer or the like which includes an ID collation unit 3, and receives an ID transmitted by each ID transmission unit 1 which is present around it. The number of IDs to be received by the ID reception unit 2 is not limited to one. The ID received by the ID reception unit 2 is sent to the ID collation unit 3.

Reference numeral 3 denotes an ID collation unit, which is implemented, e.g., when a computer executes a program. The ID collation unit 3 determines whether or not to allow the main system 7 to execute MR system contents, and sends the determination result to the main system 7.

Such determination in the ID collation unit 3 may be made based on various conditions. However, in this embodiment, determination is made based on the following conditions.

1) In principle, only when a predetermined number of IDs are received or confirmed by the ID reception unit 2, the main system 7 is granted a permission to execute MR system contents.

2) However, if software which implements an MR system when it is executed by the main system 7 is in a trial period, a permission is granted even when the IDs to be received by the ID reception unit 2 do not satisfy a given condition. In this case, if data with different qualities are available, a permission to use even data with high quality is granted.

3) When an MR system is launched for the purpose of an execution test, a permission is granted even when the IDs to be received by the ID reception unit 2 do not satisfy a given condition. In this case, if data with different qualities are available, a permission to use only data with low quality is granted.

Of these conditions, condition 1) can be checked by collating whether or not IDs received from the ID reception unit 2 correspond to real objects required to execute the MR system contents, and determining whether or not IDs not less than those which are set in the ID collation unit 3 in advance directly or via the main system 7 have been collated. Note that the IDs used in collation may be registered in advance in the ID collation unit 3 upon selling the protection apparatus 100 or may be set from the main system 7.

Also, condition 2) can be checked by determining if a trial period (e.g., 30 days) has expired by comparing an elapsed time period after installation or first execution of software, e.g., the number of days of the trial period. The starting date of calculation of the elapsed time period can be acquired from the main system 7.

Furthermore, condition 3) can be checked by acquiring information indicating whether or not the system is launched for the purpose of an execution test from the main system 7 by providing keys, buttons, and the like used to launch the system for the purpose of the execution test to the main system 7 or providing an item that allows to launch the system for the purpose of execution test to a system launch menu.

The collation result of the ID collation unit 3 is sent to the main system 7. More specifically, when it is determined based on above conditions 1) to 3) that the MR system can be executed, a message that allows execution and the collated ID are sent to the main system 7; otherwise, a message that advises accordingly is sent to the main system 7. Even when execution is not permitted, the collated IDs or received IDs may be sent to the main system 7.

When the ID collation unit 3 determines that it is impossible to execute the MR system contents or the execution test, the MR system contents protection apparatus 100 informs the user of the apparatus that execution of the MR system contents is not permitted. An arbitrary informing method may be used. For example, a display unit may be provided to the protection apparatus 100 to inform the user by displaying a message or lighting a warning lamp.

Reference numeral 7 denotes a main system which can execute an MR system on its own (using real objects contained in the contents). The main system 7 comprises, e.g., a controller 71 which is realized by a versatile computer apparatus, a position/orientation sensor 73 which is attached to the user or an image sensing unit 72, the image sensing unit 72 as, e.g., a real space image sensing camera, and a display unit 74 as, e.g., a head-mounted display (HMD).

Note that FIG. 1 illustrates the contents protection apparatus 100 as an apparatus independent from the main system 7 for the sake of simplicity. However, at least one of the ID reception unit 2 and ID collation unit 3 may be integrated with the main system 7.

The controller 71 comprises a versatile computer apparatus which has a CPU, ROM, RAM, hard disk drive (HDD), optical drive (CD or DVD drive, or the like), video card, sound card, network interface, serial interface, and the like, a display device such as a CRT, LCD, or the like and an input device such as a keyboard, mouse, and the like, which are connected to the computer apparatus, and the like. The controller 71 implements MR contents using the building components of the main system 7 by executing basic software (OS) and an MR system application that runs on the OS, which are stored in the ROM or HDD. When at least one of the ID reception unit 2 and ID collation unit 3 of the contents protection apparatus 100 is integrated with the main system 7, at least some of its functions may be implemented by a program executed by the controller 71.

The image sensing unit 72 is a video camera which is mounted on, e.g., the head of the user, and is used to sense an image of a real space, and supplies a sensed real space image signal to the controller 71.

The position/orientation sensor 73 is mounted on, e.g., the head of the user, and supplies information of the position and orientation of the user's head to the controller 71.

The display unit 74 comprises, e.g., an HMD. The user is allowed to experience mixed reality by displaying a mixed reality image obtained by superimposing a real space image sensed by the image sensing unit 72 and a virtual space image generated by the controller 71 on the display unit 74 which is visually observed by the user. When the HMD is of optical see-through type, a virtual space image alone is displayed on the display unit 74, and the virtual space image and real space are superimposed on the eyes of the user. In this case, the image sensing unit 72 may be omitted.

Note that a plurality of users may be present or a plurality of position/orientation sensors 73 are used per unit so as to detect a real object that the user users in his or her hand or to detect the position/orientation other than the head of the user depending on MR contents to be executed. However, since such arrangements of the main system 7 depending on contents are not directly related to the present invention, a detailed description thereof will be omitted.

Reference numeral 75 denotes a data storage unit, which is a large-capacity storage device (e.g., a hard disk drive) that can be accessed by the controller 71. The data storage unit 75 stores data required to execute MR system contents, e.g., CG data of virtual objects, and shape data corresponding to real objects contained in the MR system contents. The data storage unit 75 can store two different types of data, i.e., high-quality data for normal execution (including execution during a trial period) and low-quality data for an execution test per contents. For example, CG data for a virtual object has higher data quality with increasing number of polygons, and vice versa. Also, shape data corresponding to a real object has higher quality as its shape more faithfully represents that of the corresponding real object. Of course, data for normal execution may be the same as that for an execution test.

The controller 71 of the main system 7 executes MR system contents and provides MR experience to the user only when it receives from the ID collation unit 3 a message indicating that the MR system contents can be executed. The controller 71 conducts a test of MR system contents and provides MR experience to the user of the MR system contents protection apparatus only when an execution test of the MR system contents can be made.

When the main system 7 executes MR system contents, the controller 71 specifies predetermined MR system contents and data used in execution of the contents, and acquires required data from the data storage unit 75.

When the main system 7 executes MR system contents after it receives IDs from the ID collation unit 3, the controller 71 specifies MR system contents and data used in execution of the contents in accordance with the received IDs, and acquires required data from the data storage unit 75.

When the main system 7 conducts an execution test of MR system contents, the controller 71 specifies predetermined MR system contents and execution test data used in execution of the contents, and acquires required data from the data storage unit 75.

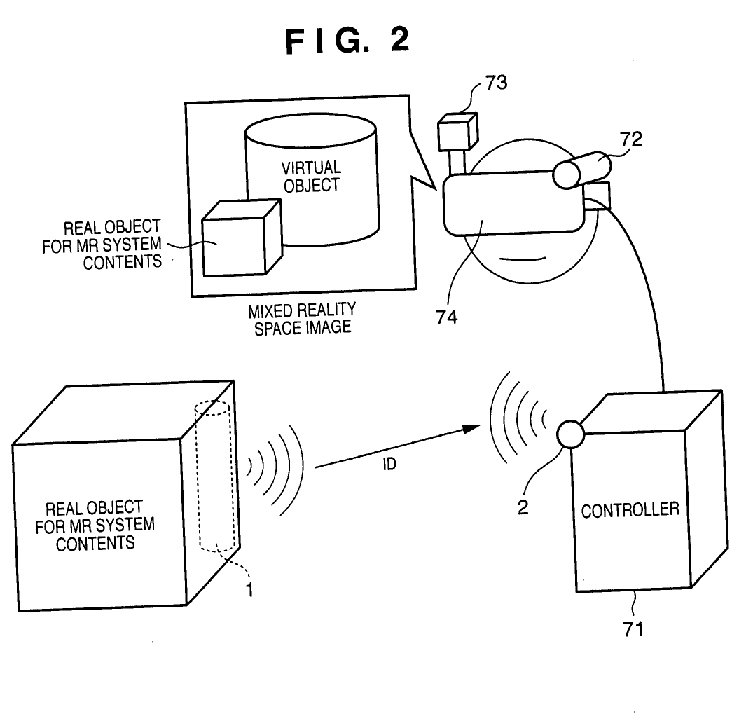

FIG. 2 illustrates a schematic arrangement of the MR system that has been explained using FIG. 1. Note that the ID collation unit 3 in FIG. 2 is implemented by a program executed by the controller 71, and the data storage unit 75 is incorporated in the controller 71.

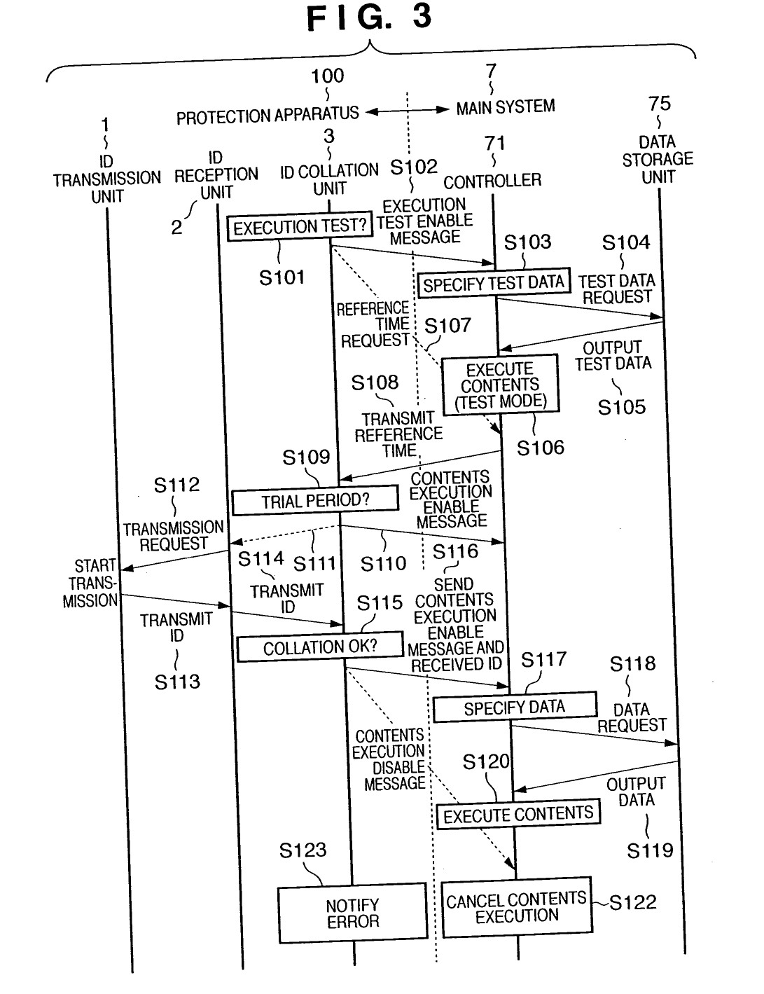

The operation of the contents protection apparatus 100 of this embodiment with the above arrangement will be described below using the sequence chart shown in FIG. 3. In the sequence chart of FIG. 3, if different processes are to be executed depending on the determination results, a process to be executed upon positive determination is indicated by the solid arrow, and a process to be executed upon negative determination is indicated by the dotted arrow.

The MR system according to this embodiment is launched. Various launch methods may be adopted depending on the relationship between the protection apparatus 100 and main system 7. For example, when the power switch of the main system 7 is turned on, the power supply of the protection apparatus 100 may be turned on. Also, when the user instructs to execute contents using, e.g., a keyboard or the like at the main system 7, the power supply of the protection apparatus 100 may be turned on.

The protection apparatus 100 executes the sequence shown in FIG. 3 not only upon power ON but also when the operator instructs to execute contents at the main system 7 or in accordance with a confirmation instruction issued by the operator at an arbitrary timing or an instruction issued by, e.g., a switch provided to the protection apparatus 100 itself (e.g., the ID collation unit 3).

In this embodiment, assume that the protection apparatus 100 checks if execution of contents is authentic, when both the protection apparatus 100 and main system 7 have completed the launch process, and the user instructs to execute contents using, e.g., a keyboard or the like at the main system 7. Note that the check process may start in response to, e.g., a request generated from the main system 7 to the ID collation unit 3 or it may start actively when the ID collation unit 3 detects a contents execution instruction at the main system 7. The latter process is easily adopted especially when the ID collation unit 3 is implemented as a part of a program executed by the main system 7.

When each ID transmission unit 1 comprises a radio transmitter, its electric power may be supplied from the ID reception unit 2 or ID collation unit 3 (or main system 7), or respective units may independently acquire their electric power from a commercial power supply or may use a battery.

The ID collation unit 3 checks if a contents execution instruction generated by the main system 7 designates an execution test (step S101). Whether or not the contents execution instruction designates an execution test can be determined as follows. That is, an item used to designate an execution test is provided to a contents execution instruction window to be displayed on the display device of the controller 71 in the main system 7, and when the operator issues a contents execution instruction by designating the execution test using an input device such as a keyboard, mouse, or the like, the controller 71 detects that instruction, and sends that information to the ID collation unit 3 or the ID collation unit 3 acquires such information.

If the ID collation unit 3 determines that the contents execution instruction designates the execution test, it sends a contents execution permission message for the purpose of execution test to the controller 71 (step S102). Upon reception of this message, the controller 71 specifies test data required to execute the execution test of the designated contents (step S103), and requests the data storage unit 75 to output test data (step S104). The data storage unit 75 outputs test data in response to this request (step S105), and the controller 71 conducts a contents execution test using the test data (step S106). If data with different qualities are available, data for the execution test is low-quality data, as described above.

On the other hand, if it is determined in step S101 that the contents execution instruction does not designate an execution test, the ID collation unit 3 requests the controller 71 of a reference time used to determine a trial period as the installation time, first execution time, or the like of MR contents designated to be executed (step S107).

In response to this request, the controller 71 reads out the reference time stored in a nonvolatile memory, hard disk drive, or the like, and sends it to the ID collation unit 3 (step S108). Note that the ID collation unit 3 may directly read out the reference time.

The ID collation unit 3 calculates the difference between the acquired reference time and the current time acquired from an internal clock, and compares it with a pre-set trial period to determine if the MR contents designated to be executed are during the trial period (step S109). If the ID collation unit 3 itself does not have any clock, it may also acquire the current time from the controller 71 as in the reference time. Also, a trial period may be set in advance in the ID collation unit 3 upon selling MR contents.

If the contents are in the trial period, the ID collation unit 3 transmits a contents execution permission message to the controller 71 (step S110). Upon reception of this message, the controller 71 specifies data required to execute MR contents (step S117), and requests the data storage unit 75 to output data (step S118). The data storage unit 75 outputs data in accordance with this request (step S119), and the controller 71 executes contents using the data (step S120).

If it is determined in step S109 that contents are not in the trial period, the ID collation unit 3 requests the ID reception unit 2 to receive an ID (step S111). In response to this request, the ID reception unit 2 requests the ID transmission unit 1 to transmit an ID (step S112). The ID transmission unit 1 transmits a pre-set ID, i.e., that of a corresponding real object via a medium (radio wave, infrared light, or the like) that the ID reception unit 2 can receive, in response to the request from the ID transmission unit 1 (step S113). Note that the ID transmission unit 1 may periodically transmit its ID while it is active without receiving any request from the ID reception unit 2.

In step S114, the ID reception unit 2 receives the ID transmitted from the ID transmission unit 1 which is present around the unit 2, and sends the received ID to the ID collation unit 3. If the ID reception unit 2 can receive a plurality of IDs, it receives all receivable IDs, and sends an ID to the ID collation unit 3 every time it receives an ID.

In step S115, the ID collation unit 3 repetitively collates if the ID received from the ID reception unit 2 is that required to execute MR system contents designated to be executed at the main system 7, every time it receives the ID from the ID reception unit 2. After an elapse of a predetermined period of time, the ID collation unit 3 confirms whether or not to receive a sufficient number or more of IDs required to execute MR system contents. The number of IDs of real objects required for contents, and the number of IDs required to permit contents execution can be set in the ID collation unit 3 directly or via the main system 7 in the manufacture or installation of the protection apparatus 100.

If it is confirmed that a sufficient number or more of IDs required to execute MR system contents are received, the ID collation unit 3 determines that MR system contents can be executed, and transmits a contents execution enable message and received IDs to the controller 71 (step S116). Upon reception of this message, the controller 71 specifies data required to execute MR contents (step S117), and requests the data storage unit 75 to output data (step S118). The data storage unit 75 outputs data in accordance with this request (step S119), and the controller 71 executes contents using the data (step S120). If the controller 71 does not require any IDs, only the contents execution enable message may be sent in step S116.

In this specification, the execution or execution test of MR system contents means providing of MR experience to the user who wears the display unit 74 of the main system 7.

On the other hand, if the ID collation unit 3 cannot confirm in step S115 that a sufficient number or more of IDs required to execute MR system contents are received, it sends a contents execution disable message to the controller 71 (step S121). Upon reception of this message, the controller 71 displays, e.g., an error message “designated MR contents cannot be executed since real objects required to execute the contents cannot be confirmed” or the like on the display device, and cancels contents execution (step S122).

Also, the collation unit 3 notifies that designated MR contents cannot be executed by means of error display, generation of an alarm sound, or the like (step S123). If the ID collation unit 3 is incorporated in the main system 7, error notification made by the controller 71 on the display device or that by the ID collation unit 3 may be made.

As described above, according to this embodiment, even in an environment that allows authentic use of software required to execute MR contents, execution of the MR contents without a real object required for that contents is disabled, thus preventing illicit use without any authorized real objects.

(Second Embodiment)

In the first embodiment described above, MR contents execution data saved in the data storage unit 75 is not encrypted, and no measure is taken in terms of prevention of illicit use of data such as three-dimensional (3D) data of a real object and the like, which can be re-used independently. In this embodiment, MR contents execution data is encrypted, and when the ID collation unit 3 receives a contents execution enable message, the data is decrypted and used, thus further preventing illicit use of data itself.

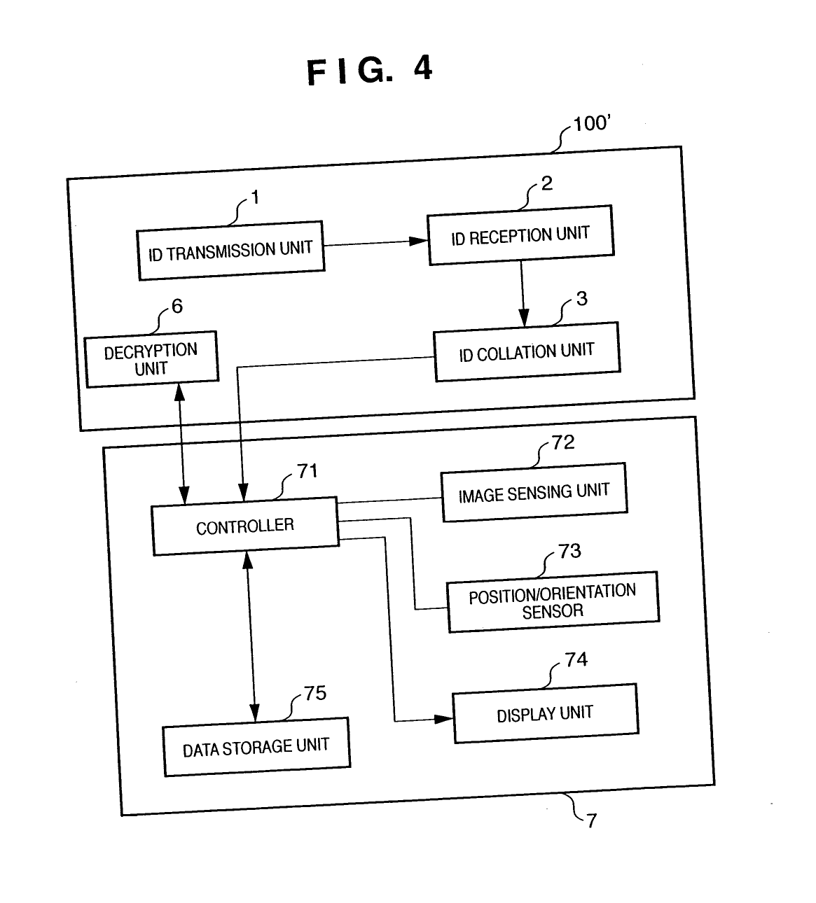

FIG. 4 is a schematic block diagram showing an example of the arrangement of the overall MR system that uses an MR system contents protection apparatus according to the second embodiment of the present invention. As can be seen from comparison with the arrangement according to the first embodiment shown in FIG. 1, a contents protection apparatus 100′ according to this embodiment is substantially the same as the contents protection apparatus 100 according to the first embodiment, except that it newly has a decryption unit 6. Therefore, an explanation of this embodiment will be given focusing on the decryption unit 6 and its process, and a repetitive description will be avoided.

Data which are stored in the data storage unit 75 of the main system 7 and are required to execute MR contents are encrypted in advance by a predetermined method. An encryption method is not particularly limited. For example, public key cryptosystem (especially, RSA cryptography) may be used. In this case, data stored by the data storage unit 75 are encrypted using a public key.

The decryption unit 6 decrypts encrypted data received from the controller 71. For example, when data is encrypted by public key cryptosystem, data is decrypted using a secret key for decryption, which is stored in advance. Also, an ID which is received by the ID reception unit 2 and is collated by the ID collation unit 3 may be received from the main system 7, and may be used as a secret key for decryption. In this case, when data that can be decrypted using one ID is limited to 3D data of a real object corresponding to that ID, some real objects may be sold as options upon selling MR contents. When the user additionally purchases a real object as an option, a real object corresponding to that real object is automatically decrypted.

Furthermore, a secret key may be calculated based on the received ID. For example, a secret key may be obtained by applying the ID to a predetermined secret key calculation formula, or a required secret key may be acquired from a combination table of secret keys and IDs, which is stored in advance.

Note that the decryption unit 6 may be implemented as a part of a program executed by the controller 71 of the main system 7 like the ID collation unit 3, may be incorporated in the main system 7 as a decryption chip, or may be provided as an external device of the main system 7.

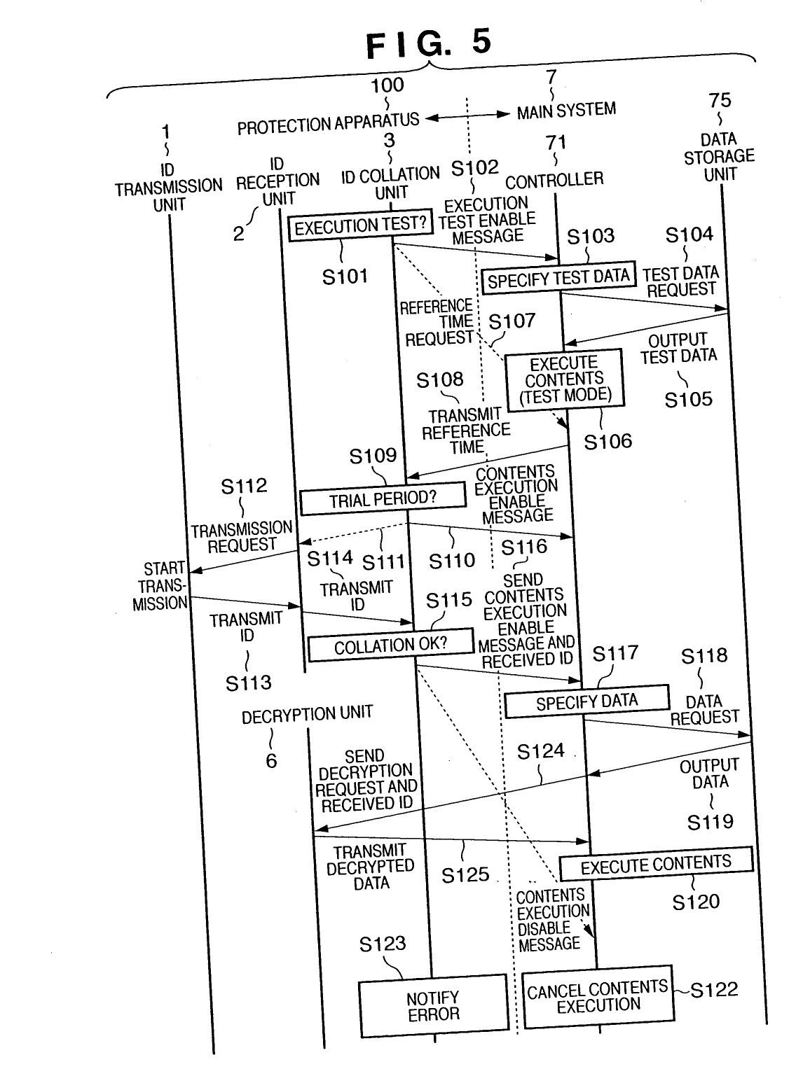

The operation of the contents protection apparatus 100′ of this embodiment with the above arrangement will be explained below using the sequence chart shown in FIG. 5. The same step numbers in FIG. 5 denote the steps of executing the same processes as those in the sequence chart in FIG. 3 explained in the first embodiment, and a description thereof will be omitted.

Note that execution test data is not encrypted in FIG. 5 for the sake of simplicity, but may also be encrypted. In this case, the execution test data is decrypted in the same manner as normal operation data to be described below. However, since no ID is received in the execution test, data is decrypted by a decryption method that does not require any ID (e.g., using a secret key for decryption prepared in advance).

In FIG. 5, processes after steps S115 to S119 in which the ID collation unit 3 determines as a result of collation that contents can be executed and the controller 71 that receives a message specifies and acquires data required to execute the contents are different from those in FIG. 3 described in the first embodiment.

If the controller 71 detects that the acquired data is encrypted, it sends a decryption request to the decryption unit 6, and sends IDs received from the collation unit 3 and data acquired from the data storage unit 75 to the decryption unit 6 (step S124). Note that the decryption unit 6 may acquire the IDs from the ID collation unit 3 after it receives the decryption request. In this case, the main system 7 sends only encrypted data and need not transmit any IDs. Whether or not data is encrypted can be determined by an arbitrary method. For example, the header of data may include a storage field of information indicating the presence/absence of encryption, and the controller 71 may detect the presence/absence of encryption by referring to that field.

The decryption unit 6 decrypts the encrypted data received from the controller 71 using, e.g., a secret key, as described above, and sends back decrypted data to the controller 71 (step S125). The controller 71 executes contents using the data (step S120). For example, if IDs required to decrypt some of encrypted data are not received, i.e., if encrypted data received from the controller 71 include data that cannot be decrypted, the decryption unit 6 sends a message indicating that decryption cannot be made to the controller 71. This message can be set by setting a flag indicating a decryption error in the header of an encrypted data file and sending back that file. When data which cannot be decrypted is found, the controller 71 executes MR contents without using that data, and may advise the operator accordingly.

If the trial period is determined in FIG. 5, the controller 71 also informs the trial period together with the decryption request, and the decryption unit 6 decrypts data using a master key with which one can decrypt all data without using any ID upon reception of such information.

In this way, according to this embodiment, data to be stored in the data storage unit 75 are encrypted, and are decrypted and used only when it is determined that contents can be executed, thus preventing illicit use of data itself.

The above embodiments consider contents execution for the purpose of an execution test and the trial period. However, the gist of the present invention lies in preventing illicit use without using any authorized real objects which partially form a product that implements MR contents, and determination of whether an execution of the contents is to be authorized or not in consideration of contents execution for the purpose of an execution test and the trial period is not essential.

That is, the simplest form of the contents protection apparatus according to the present invention is granting a permission to execute MR contents only when a predetermined number of pieces of information, which specify real objects required for the MR contents to be executed can be confirmed.

In the detailed processes in the above embodiments, only an ID transmitted by each ID transmission unit 1 has been explained as information used to specify a real object. However, as described above, a 2D barcode or the like, which does not actively transmit information, may be used as the ID transmission unit 1. In such case, the ID transmission unit 1 such as a 2D barcode which is attached to a real object, may be sensed by the image sensing unit 72 of the main system 7, and a 2D barcode detected by an image process is compared with that which is registered in advance, thus achieving ID collation. In this case, the controller 71 may supply image data sensed by the image sensing unit 72 to the ID collation unit 3, which may execute an image process and collation process.

As a method of permitting to execute MR contents, the contents protection apparatus according to the present invention may control power ON of the main system 7 more simply. That is, when a power ON instruction of the main system 7 is issued, the contents protection apparatus according to the present invention may be launched, and may supply electric power to the main system 7 only when it is determined that execution is permitted. More specifically, a relay which controls to turn on/off the power supply of the main system 7 may be controlled by the ID collation unit 3.

Note that the present invention includes a case wherein the equivalent functions are achieved by supplying a software program that implements the functions of the aforementioned embodiments directly from a recording medium or using wired/wireless communications to a system or apparatus having a computer that can execute the program, and executing the supplied program by the computer of that system or apparatus.

Therefore, the program code itself supplied to and installed in the computer to implement the functional process of the present invention using the computer implements the present invention. That is, the present invention includes the computer program itself for implementing the functional process of the present invention.

In this case, the form of program is not particularly limited, and an object code, a program to be executed by an interpreter, script data to be supplied to an OS, and the like may be used as along as they have the program function.

As the recording medium for supplying the program, for example, magnetic recording media such as a flexible disk, hard disk, magnetic tape, and the like, optical/magnetooptical storage media such as MO, CD-ROM, CD-R, CD-RW, DVD-ROM, DVD-R, DVD-RW, and the like, nonvolatile semiconductor memory, and so forth may be used.

As a program supply method using the wired/wireless communications, a server on a computer network may store a data file (program data file) that can be a computer program which forms the present invention on a client computer, such as the computer program itself which forms the present invention, a compressed file including an automatic installation function, or the like, and the program data file may be downloaded to the client computer which establishes connection to the server. In this case, the program data file may be segmented into a plurality of segment files, which may be allocated on different servers.

That is, the present invention includes a server apparatus which makes a plurality of users download the program data file for implementing the functional process of the present invention on a computer.

Also, a storage medium such as a CD-ROM or the like, which stores the encrypted program of the present invention, may be delivered to the user, the user who has cleared a predetermined condition may be allowed to download key information that is used to decrypt the program from a home page via the Internet, and the encrypted program may be executed using that key information to be installed on a computer, thus implementing the present invention.

The functions of the aforementioned embodiments may be implemented not only by executing the readout program code by the computer but also by some or all of actual processing operations executed by an OS or the like running on the computer on the basis of an instruction of that program.

Furthermore, the functions of the aforementioned embodiments may be implemented by some or all of actual processes executed by a CPU or the like arranged in a function extension board or a function extension unit, which is inserted in or connected to the computer, after the program read out from the recording medium is written in a memory of the extension board or unit.

As described above, according to the present invention, MR contents are inhibited from being executed if no authorized real objects contained in MR system contents exist, and illicit use of MR system contents can be prevented.

As many apparently widely different embodiments of the present invention can be made without departing from the spirit and scope thereof, it is to be understood that the invention is not limited to the specific embodiments thereof except as defined in the appended claims.

What is claimed is:

1. A mixed reality contents protection apparatus for preventing illicit use of contents for a mixed reality system that mixes and presents a virtual space image on a landscape of a real space, comprising:
ID transmission unit, attached to a real object, adapted to transmit a predetermined ID;
ID reception unit adapted to receive the ID; and
ID collation unit adapted to determine whether an execution of the contents by the mixed reality system is to be authorized or not on the basis of whether or not the received ID corresponds to a real object required for the contents to be executed by the mixed reality system, and sending a determination result to the mixed reality system.

2. The apparatus according to claim 1, wherein said ID collation unit determines that the contents can be executed when not less than a predetermined number of IDs corresponding to real objects required for the contents to be executed by the mixed reality system are received.

3. The apparatus according to claim 1, wherein said ID collation unit determines that the contents can be executed irrespective of the received ID when the contents to be executed by the mixed reality system are in a trial period, or are to be executed for the purpose of an execution test.

4. The apparatus according to claim 1, wherein data of the contents to be executed by the mixed reality system are encrypted, and said apparatus further comprises decryption unit adapted to decrypt data of contents which are determined by said ID collation unit to be able to be executed, and supplying decrypted data to the mixed reality system.

5. A mixed reality contents protection method for preventing illicit use of contents for a mixed reality system that mixes and presents a virtual space image on a landscape of a real space, comprising:
an ID transmission step of making an ID transmission unit attached to a real object transmit a predetermined ID;
an ID reception step of receiving the ID; and
an ID collation step of determining whether an execution of the contents by the mixed reality system is to be authorized or not on the basis of whether or not the received ID corresponds to a real object required for the contents to be executed by the mixed reality system, and sending a determination result to the mixed reality system.

6. The method according to claim 5, wherein the ID collation step includes a step of determining that the contents can be executed when not less than a predetermined number of IDs corresponding to real objects required for the contents to be executed by the mixed reality system are received.

7. The method according to claim 5, wherein the ID collation step includes a step of determining that the contents can be executed irrespective of the received ID when the contents to be executed by the mixed reality system are in a trial period, or are to be executed for the purpose of an execution test.

8. The method according to claim 5, wherein data of the contents to be executed by the mixed reality system are encrypted, and the method further comprises a decryption step of decrypting data of contents which are determined in the ID collation step to be able to be executed, and supplying decrypted data to the mixed reality system.

9. A computer readable recording medium storing a program code for making a computer execute a method for preventing illicit use of contents for a mixed reality system that mixes and presents a virtual space image on a landscape of a real space, said program code comprising:
a program code of an ID transmission step of making an ID transmission unit attached to a real object transmit a predetermined ID;
a program code of an ID reception step of receiving the ID; and
a program code of an ID collation step of determining whether an execution of the contents by the mixed reality system is to be authorized or not on the basis of whether or not the received ID corresponds to a real object required for the contents to be executed by the mixed reality system, and sending a determination result to the mixed reality system.
